(19) United States
(12) Patent Application Publication
(10) Pub. No.: US 2009/0149205 A1
(43) Pub. Date: Jun. 11, 2009

(54) System And Method For Regulating Data Messaging Between A Wireless Device And A Mobile Communication Device Using Short Message Service

(75) Inventors: Rafael Heredia, Easley, SC (US); Michael Wayne Crowe, Clover, SC (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Zipit Wireless Inc., Greenville, SC (US)

(21) Appl. No.: 12/332,056

(22) Filed: Dec. 10, 2008

Related U.S. Application Data
(60) Provisional application No. 61/007,027, filed on Dec. 10, 2007.

(51) Int. Cl. H04W 4/12

(52) U.S. Cl. 455/466

(57) ABSTRACT

A computer network communication device enables a parent/administrator to control data communication sessions between the device and a mobile communication device that may be accessed through a cellular network. The computer network communication device includes a device identifier stored in the device, a communication module configured to download rules corresponding to the device identifier from a control site remote from the device, and a processor configured to process data messages received from other computer network communication devices over a computer network with reference to the downloaded rules.

### TECHNICAL FIELD

This invention relates to data communications and, more particularly, to data communication between wireless devices using a short message service protocol.

### BACKGROUND

Instant messaging (IM) is used to describe a computer network service for the communication of textual messages between users in a real-time manner. Three major providers of instant messaging services are America On-Line Instant Messaging (AIM), Microsoft Network (MSN) Messenger, and Yahoo Instant Messenger. These providers enable subscribers to access an instant messaging service through a subscriber's Internet service provider (ISP). To access the instant messaging service, a subscriber uses a computer terminal executing an instant messaging application program to couple to an ISP and then access an instant messaging service. Once the instant messaging service is accessed, the user may query the service for identification of the “buddies” that are currently accessing the instant messaging service provider. “Buddies” are other subscribers to the instant messaging service that a subscriber has identified as a possible recipient for instant messages. The buddies are identified by including their instant messaging service usernames in a subscriber's buddy list. A subscriber may then initiate an instant messaging session with a buddy by typing and addressing a textual/graphical message to one of the buddies on the messaging service. When the subscriber activates the sending function for the message, the messaging service communicates the message to a buddy and activates a notification feature, such as an audio file, to inform the buddy that a message has been received through the instant messaging service. The buddy may then view the message, type a response, and send it through the messaging service. The conversation may continue in this manner until one of the parties terminates the session.

Communication terminals for receiving textual and graphic messages are well-known. These terminals include cellular telephones, two-way pagers, personal digital assistants (PDAs), and handheld computers, which are commonly known as palmtop computers. One novel terminal that integrates the functions required for instant messaging with wireless communication capabilities in a handheld terminal is disclosed in co-pending patent application Ser. No. 10/846,236, which is entitled “Instant Messaging Terminal Which Is Adapted For WI-FI Access Points” and which has issued as U.S. Pat. No. 7,292,870 on Nov. 6, 2007. The disclosure of that patent is hereby expressly incorporated by reference in its entirety in this document.

Instant messaging terminals are frequently used to communicate with an instant messaging service provider through wireless access points. A wireless access point includes a radio transceiver and server that typically implement the 802.11b, 802.11a, 802.11g, 802.11n, or some other known wireless communication standard that supports internet or other wide area network communications. Locations providing wireless access points for the Internet are commonly referred to as “hotspots.” These hotspots are local area networks (LANs) and devices on such a LAN may be coupled to the Internet. The provision of wireless Internet access can be an important draw for an establishment, such as a coffee shop or the like. However, the access point must be implemented with care to reduce the risk that unscrupulous computer users will attempt Internet access through the access point for the purposes of web site hacking with an enhanced degree of anonymity. Design aspects considered in the implementation of a hotspot include the radius in which the transceiver effectively communicates and the security scheme that allows a customer to use an access point. Typically, the transmission power of the transceiver is limited to a level so the radiation pattern does not extend past the boundaries of the commercial premises to reduce the risk of unobserved access to the local network through the access point. Additionally, a security method, such as Wired Equivalent Privacy (WEP) or Wi-Fi Protected Access (WPA), is implemented by the access point components to determine whether Internet access is granted through the access point.

To avoid lengthy cables in a home or small office environment, many of these locations use wireless routers to communicate wirelessly with computers located in the home or office. The wireless router enables the computers wirelessly coupled to it to access the Internet. By using a Wi-Fi router, computers in the home or office are coupled together in a LAN without requiring cables to be coupled between the computers and the router for communication purposes. Correspondingly, any computers or other terminals capable of wirelessly accessing the Internet that also include an instant messaging application are capable of communicating via instant messages with other buddies through the instant messaging service.

Cellular telephones are also capable of communicating with other computers using an instant messaging service. As is well known, the cellular telephone may include an instant messaging application that accesses an instant messaging service through the cellular network and a wide area network (WAN) or local area network (LAN). In other words, the cellular telephone operates in much the same way that a computer executing an instant messaging application operates to communicate through instant messaging except the messages are communicated, at least partially, over the cellular network, although other computer communication networks may comprise a portion of the communication path. The drawback of this instant messaging system is the relatively expensive cost of communicating over a cellular network. In the situation described above, the telephone connects with a computer communication network through a cellular telephone connection. As long as this connection remains open, the telephone subscriber is billed for the access. Depending upon the length of the session, the charges may be quite high. More recently, some cellular telephones include wireless communication transceivers, such as Wi-Fi transceivers, that communicate wirelessly with a WAN or LAN access point for computer network communication between an IM application on the phone with another IM device through an instant messaging service.

Another way in which mobile telephones may be used to communicate textually with other telephones is through a Short Message Service (SMS). In this communication alternative, a SMS application on the telephone enables a user to compose a textual message, select or enter another telephone number, and then send the composed message to the selected or entered telephone number. While the textual message is sent over the cellular network, it is a single message with a relatively short connection time on the cellular number. Hence, the cost of sending the textual message is cheaper than an instant messaging session.

In an effort to integrate instant messaging with SMS, U.S. Pat. No. 6,957,077 to Dehlin, proposes to include an IM client program on a mobile telephone. To enable IM communications, a cellular telephone subscriber enrolls on an IM/SMS server with an alias that is associated with the subscriber's telephone number. The telephone subscriber can then provide the alias to another person having an IM terminal. To initiate contact with the telephone subscriber, the person using the IM terminal may send an IM message for the alias to the IM/SMS server. The IM/SMS server, or an application on the server, converts the IM message to a specialized SMS message that is transmitted over the cellular network to the telephone associated with the alias. An indicator notifies the telephone user of the message receipt. After reviewing the message, the telephone user may generate a reply message with the IM client and activate a send function. The IM client generates another specialized SMS message that is sent over the cellular telephone network to the IM/SMS server. The IM/SMS server then converts the specialized SMS message into an IM message that is sent to the IM terminal. This process may be repeated to provide an IM-like session. The IM terminal user does not know the alias is communicating with a cellular telephone. Only the telephone user is aware that the textual messages are being communicated through a cellular telephone.

While the method and system described in the '077 patent emulate an instant messaging session, they require that the cellular telephone be modified for operation in this manner. Specifically, the telephone must download and store the IM client for execution to manage the IM communications that use the specialized SMS messages. An approach that avoids this modification would be useful.

Other known IM services enable users to identify IM recipients or buddies as being associated with cellular telephone numbers. Messages sent to these buddies are sent to SMS servers where they are converted to standard SMS messages and transmitted over the cellular network servicing the telephone number to the telephone corresponding to the cell number. Messages from the phone are converted by the SMS server into a data message that is returned to the IM user. The messages are displayed in an IM session window on the user's computer or terminal.

While these IM methods enable IM sessions to occur between IM devices and mobile communications, they also provide unscrupulous persons with access to IM users, some of whom are young people or children. Anyone learning of another person's IM identifier and IM service provider may later use a cell phone to send a message to that person. Thus, an eavesdropper may learn an IM identifier and IM service provider at a publicly accessible wireless hotspot and then later attempt to initiate an IM session with that person through a cell phone. In this manner, the eavesdropper is able to cloak his or her identity and clandestinely communicate with the unsuspecting recipient.

Instant messaging has increased in popularity partially because hotspots and wireless routers have made instant messaging access points ubiquitous. The ease of instant messaging service access, however, has provided younger users with a mode of communication that is less perceptible to parents than the auditory communication that occurs with telephones. As instant messaging has become increasingly popular with younger users, the features of instant messaging terminals have evolved to provide the users with other features, such as Internet radio stations, voice over IP (VoIP) telephone service, and podcasts. Parents are legitimately concerned regarding the distractions these terminals present to their children as well as the access to their children that instant messaging may provide others.

### SUMMARY

A computer network communication device enables a parent/administrator to control data communication sessions between the device and a mobile communication device accessed that may be accessed through a cellular network. The computer network communication device includes a device identifier stored in the device, a communication module configured to download rules corresponding to the device identifier from a control site remote from the device, and a processor configured to process data messages received from other computer network communication devices over a computer network with reference to the downloaded rules.

The mobile computer network communication device may be used in a system that enables regulation of data communication sessions with a mobile telephone. The system includes a mobile computer network communication device that communicates data messages generated in a Short Message Service (SMS) server protocol with a SMS server, a SMS server that receives the data messages in the SMS server protocol and transmits SMS messages over a computer communication network, a control server that stores rules for operation of the computer network communication device, and a computer network communication device coupled to the SMS server and the control server through the computer communication network, the computer network communication device processing data messages received from the mobile computer network communication device with reference to rules downloaded from the control server that correspond to the mobile computer network communication device.

### BRIEF DESCRIPTION OF THE DRAWINGS

FIG. 1 is a diagram of a system that enables a wireless data communication session between a computer network communication device and a mobile telephone that is comprised of SMS messages.

FIG. 2 is a perspective view of an instant messaging terminal that executes an instant messaging application program that enables the terminal to generate and display an IM window containing the text data in SMS messages.

FIG. 3 is a block diagram of the components that may be used to implement the instant messaging terminal shown in FIG. 2.

FIG. 4 is a flow diagram of an example of a process for regulating use of a computer network communication device with reference to a unique device identifier.

FIG. 5 is a flow diagram of an administrative process for setting rules and controls to regulate use of a mobile communication device.

FIG. 6 is a flow diagram of a process for initializing an IM device to operate with reference to rules downloaded from a control site.

FIG. 7 is a flow diagram of a process for parsing user commands with reference to the downloaded rules.

FIG. 8 is a flow diagram of a process that enables an IM session to be communicated between an IM device and a SMS server.

FIG. 9 is a flow diagram of a process that enables a parent/administrator to review a log of messages between an IM device and a cellular telephone.

FIG. 10 is a flow diagram of a process that enables a one-way communication device to process messages with reference to rules from a control site.

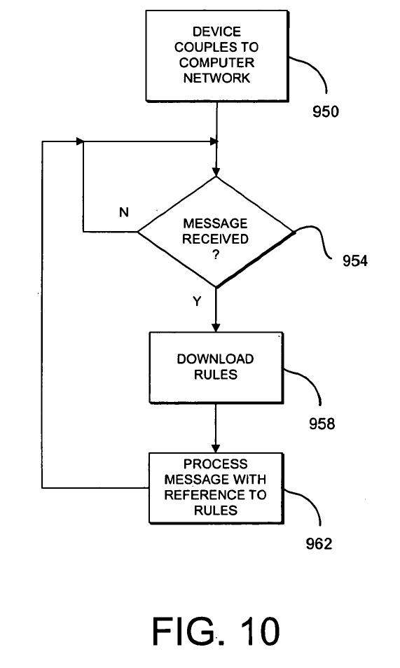

### DETAILED DESCRIPTION

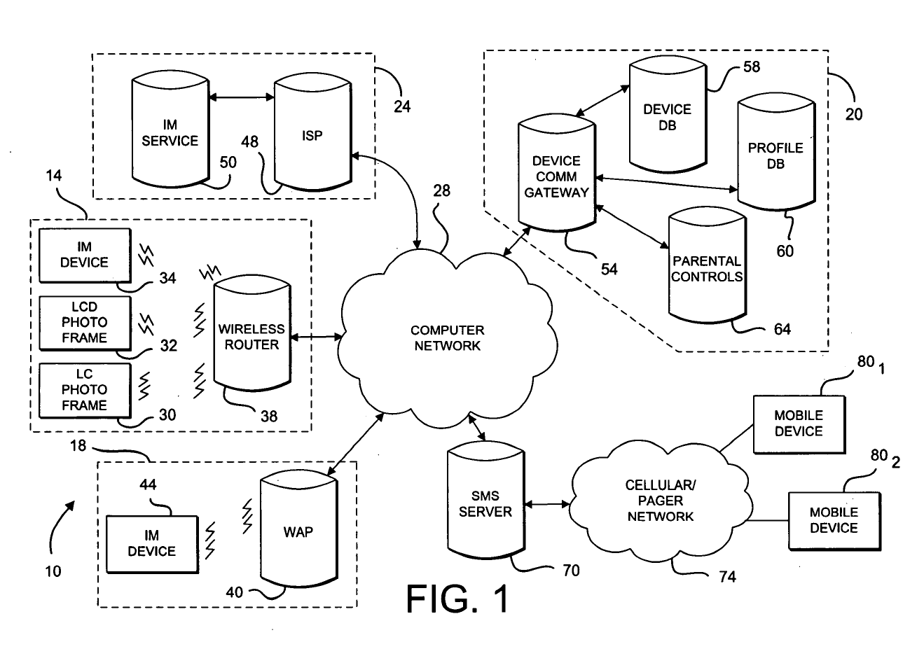

A system in which an instant messaging (IM) window may be generated from Short Message Service (SMS) messages is shown in FIG. 1. The system 10 includes a home location 14, a remote site location 18, a device regulation/support site 20, an internet service provider site 24, an SMS server 70, a cellular network 74, and mobile communication devices 80₁ and 80₂. The sites and locations are coupled to one another through a computer network 28 and the SMS server 70 couples the cellular network 74 and the mobile communication devices to the computer network 28. The computer network may be the Internet, the World Wide Web, WANs, LANs, and/or any other type or combination of types of computer communication networks. The home location has a local area network (LAN) that may include a personal computer (PC) 30, a mobile computer communication device, such as an instant messaging terminal 34, and a data receiving and displaying device, such as a LCD photo frame 32. These devices communicate with the ISP site 24 or the device regulation/support site 20 through a wireless router 38. The wireless router may wirelessly communicate with the devices at the home site 14 in accordance with one of the IEEE 802.11b, 802.11a, 802.11g, 802.11n, WiMax, or cellular network standards, for example. Using the wireless router 38, the PC 30, photo frame 32, and IM device 34 may access the ISP site 24 and through the IDS site access the device regulation/support site 20.

The wireless router 38 implements a network access controller that uses smart filters to select the packets that are communicated through the wireless gateway. Typically, the wireless gateway is involved in user authentication for regulating access to the network 28 coupled to the wireless router. The wireless router 38 may include or be coupled to an IP address allocation server. This server is sometimes known as a Dynamic Host Configuration Protocol (DHCP) server. Its function is to assign IP addresses to the devices coupled to the router so they have unique IP addresses for communication. The IP addresses most likely assigned to the devices coupled to the wireless router are private IP addresses. These private IP addresses are typically mapped to a single public IP address by a network address/port translator that is a component of the wireless router 38. The network address/port translator is able to determine the corresponding private IP address for messages received from the network 28 that only have the public IP address. Alternatively, the wireless router 28 may use Media Access Controller (MAC) addresses of the devices coupled to it for identifying the devices coupled to the wireless router.

The remote site 18 includes a wireless access point 40 through which another mobile device 44, such as another IM terminal, may access the ISP site 24 and the device regulation/support site 20. The wireless access point 40 may include additional software and hardware to monitor usage occurring on the remote site premises. The remote site may be a commercial establishment, such as a restaurant or coffee shop, an airport, or other type of location where wireless hotspots are provided.

The ISP site 24 includes an ISP host server 48. The ISP host server is a gateway to the ISP services and typically requires a computer user attempting to access the ISP services to identify itself with a username and password. Once the ISP host server confirms a user account exists with the ISP, the services supported by the ISP may be accessed. These services are supported by numerous other servers that provide the computer communications for web page hosting, email services, search engines, and the like. The servers and databases supporting these services may be coupled to the ISP host 48 through WANs, or LANs, including the Internet. One ISP service server that may be provided is an instant messaging service server 50. The instant messaging service server 50 also verifies that any person attempting to access the instant messaging service has an instant or text messaging account with the service. This verification typically includes password processing. After the subscriber gains access to the instant messaging service, the instant messaging server notifies the subscriber of any buddies that are currently online. The instant messaging service, thereafter, relays messages between subscribers coupled to the instant messaging server.

The wireless internet service server 50 may be a component of an Internet service provider as shown in FIG. 1 or it may be a service independent of the Internet service provider. To support instant messaging, an instant messaging (IM) service includes components for routing messages between subscribers and administrating the accounts for the subscribers. For messages communicated to other instant message subscribers supported by other ISPs, the messages are communicated over the network 28 to the ISP through which the subscriber reaches the IM service. In the system 10 of FIG. 1, the mobile communication device 34 communicates with the IM service server to communicate with other subscribers. The device 34, however, also communicates with the regulation/support site 20 to configure the device and to regulate the use of the device.

The device regulation/support site 20 includes a device communication gateway 54 that communicates with a device database 58, a profile server 60, and a regulation database 64. The device regulation/support site 20 is not part of the instant messaging service supported by the IM server 50. Instead, the device regulation/support site 20 provides support services for computer network communication devices that have been registered with the site. In order to provide these services, the regulation site 20 includes identification data for the devices supported by the site. These identification data are supplied to the site by the manufacturers of the computer network communication devices and are stored in the device database 58. These identification data are unique for each device. By allowing registration of only those devices made by particular manufacturers, the operator of the regulation site is assured the devices have the requisite capabilities for the services provided by the site. The profile server 60 enables users to select and customize device configurations that may be stored at the site by the profile server 60. The regulation database 64 stores the controls and rules selected or generated by an administrative user for a device registered with the regulation/support site 20. These are the rules and controls applied to communications made with a particular mobile device registered with the site 20. These rules and controls are downloaded to a device in response to the device logging onto a computer network that is coupled to the regulation/support site 20. By applying the rules and controls to device communications, rather than account communications, the system 10 reduces the risk that an young user is able to access instant messaging or other communication services through an alternative account without application of the rules and controls. As long as a user is using a device registered with the site 20, the rules and controls are applied to communications from the device 34 regardless of the user account or name through which the instant messaging or communication service is being accessed.

The SMS server receives data messages that are generated in a SMS server protocol. As described in more detail below, IM devices as well as other wireless two-way communication devices may generate data messages in a SMS server protocol for receipt by users having a cellular telephone number as an address. The SMS server protocol messages are sent to the SMS server. Using the cellular telephone number identified in the SMS server protocol message, the SMS server transmits an SMS message over the cellular network to a mobile communication device in a known manner. The mobile network communication device may use a standard SMS application program and processor in the device to generate a SMS message containing text data corresponding to a reply entered by the device user. This message is sent to the SMS server 70. The SMS server generates a data message in the SMS server protocol that includes the reply data and transmits the data message over the computer communication network 28 to the IM or other wireless two-way communication device that sent the SMS server protocol message. The two-way communication device parses the data messages received from the SMS server and evaluates them with reference to the downloaded rules. Thus, the user of the IM terminal cannot receive messages from a cellular telephone unless the cellular telephone communicates with the SMS server to which the IM device is coupled and unless no rule prevents the communication with that particular cellular phone number.

In a similar manner, a one-way communication device, such as a LCD photo frame, may receive photo data from a camera in a cellular telephone. Upon logging onto a network coupled to the computer network 28, the photo frame communicates with the regulation/support site 20. Thereafter, attempts by a cellular telephone user to send photos or other messages to the photo frame are processed by the photo frame with reference to the rules stored at the site 20 for the photo frame or other one-way device. Thus, the photo frame or other one-way device may be enabled to receive photos from only authorized devices or data sources, such as particular image databases.

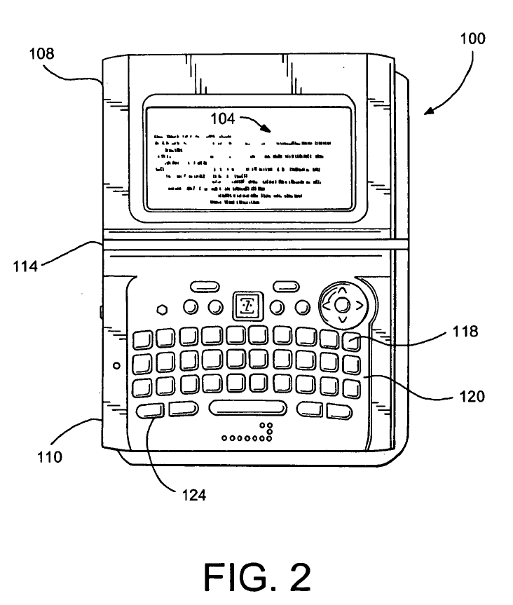

An implementation of an instant messaging terminal that communicates with SMS messages and that generates IM windows for cellular telephone communications is shown in FIG. 2. The terminal 100 includes a display 104 on which conversation session windows are displayed. The display 104 is preferably an LCD display incorporated within a lid 108 of a clamshell configuration. Located within the bottom 110 of the clamshell configuration are the components that implement the control module, communications module, and other system elements for the terminal. The lid 108 and bottom 110 of the clamshell configuration are pivotally joined to one another by a hinge 1 14. Located on the surface of the bottom 110 is a data entry device 118 that is comprised of a QWERTY keyboard section 120, and a pre-programmed emotion key 124, although non-QWERTY keyboards or input devices that do not use keyboards may be used as well. Although terminal 100 is shown in a clamshell configuration, the terminal may be implemented in other terminal arrangements, such as a handheld terminal that integrates the display and keyboard in an arrangement that does not fold so the display is always exposed.

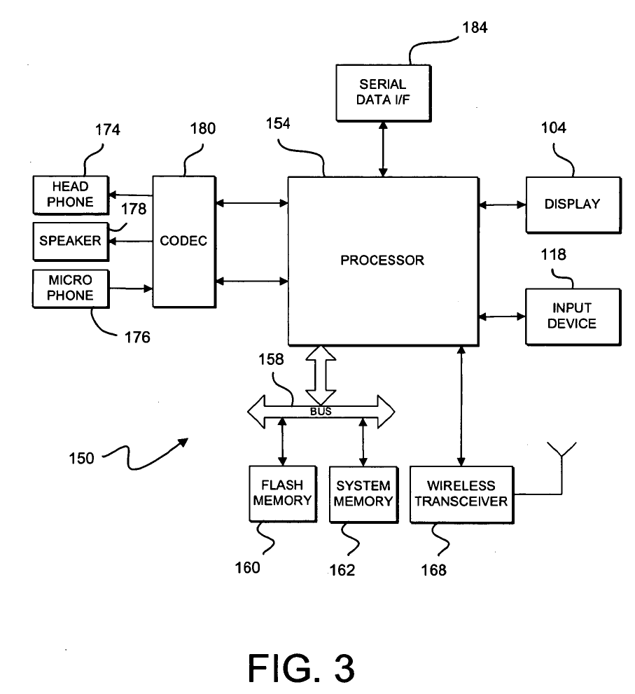

The components for implementing a communication device 34 are shown in FIG. 3. The system 150 includes a processor 154 that is coupled through a system bus 158 to memory components 160 and 162. A wireless transceiver 168 is also coupled to the processor 154 for bi-directional wireless communication with a wireless router or other wireless access point device. The processor 154 may be a controller, such as an Intel PXA270 operating at 312 MHz with an internal memory for the storage of an operating system and application program that implement the display, instant messaging and session protocols. However, other processors, ASICs, operating systems, and the like may be used to implement the terminal. The memory component 162 is a system memory used for managing the operation of the terminal and the memory component 160 may be used to update parameters and user settings for the operation of the terminal. Memory 160 or 162 may be used to store a unique identifier that is installed by the manufacturer of the device 34. The unique identifier is also stored in the device database of the regulation/support site 20. The memories 160 and 162 are non-volatile so the unique identifier remains the same during the life of the device. The unique identifier enables the regulation of the device to be implemented without recourse to a user or account identification.

In further detail, the wireless transceiver 168 preferably implements one of the IEEE 802.11 standards, such as 802.11a, 802.11b, 802.11g, 802.11n, WiMax, or other known wireless communication standard, although components supporting other short range communication standards for hot spots or other LANs may be used. The wireless transceiver 168 may radiate a signal through a cabled antenna that may be coupled to the housing of the terminal or through an antenna etched or otherwise provided on a printed circuit card.

Also coupled to the processor 154 are the display 104 and the data entry device 118. The display 104 is preferably a 320×240 color display, although other display types may be used as well. Clock circuitry (not shown) that is preferably capable of providing a 32.768 KHz and 13 MHz signal is coupled to the processor 154. A headphone jack 174, a speaker 178, and a microphone 176 are coupled to the processor 154 through a codec 180 so analog signals from the microphone may be converted to digital signals for processing by the system and so digital signals generated by the system may be converted to analog signals to drive the speaker and headphone to produce audible sound for a user. A serial data interface 184 is also provided for coupling the system 150 to other types of data communication systems.

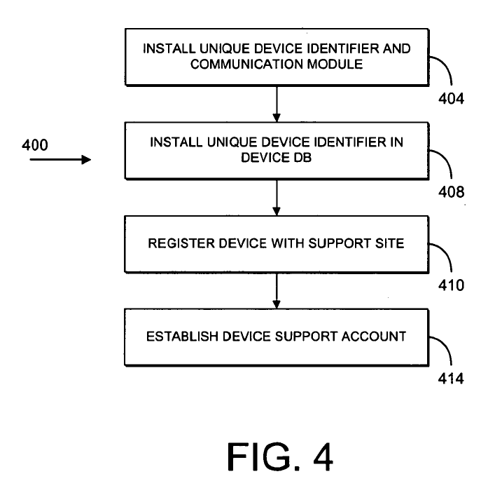

A process 400 that enables regulation and support for computer network communication devices is shown in FIG. 4. The process begins with the manufacturer installing a unique identifier and a support communication module in a communication device at the manufacturing facility (block 404). The manufacturer also installs the unique identifier in the device database 58 (block 408). The unique identifier may be numeric or alphanumeric. It may be a value output by a hashing function or other process for generating unique identifiers for the communication devices. The unique identifier is stored in non-volatile memory so it remains constant with the communication device identified by the unique identifier. The communication module is configured to communicate with the regulation/support site 20 in response to the communication module being coupled to the network 28. The communication module may be processor instructions to be executed by the processor 154. These instructions are stored in the system memory and are executed in response to a communication session over the network 28 being initiated. Alternatively, the communication module may be implemented with an ASIC or a combination of hardware and software components with the dedicated function of communicating with the regulation/support site 20. The communication module is configured to deliver the unique identifier to the regulation/support site 20 for verification that the device is enabled for support functions provided by the site 20 and to execute commands received from the control site that implement the rules and controls that regulate use of the communication device on the network 28.

After the unique identifier is installed in the device and the device database, the device is registered with the support site 20 (block 410). Registration is described in more detail below. In the registration process, an administrative user for the device is identified with an administrator name and password. The administrative user may then modify the default rules and controls for the communication device. These rules and controls are stored in the parental control database 64 in association with the unique identifier. While the control database 64 is shown as a single server, it may be comprised of multiple databases and servers for supporting the regulation function. After the administrator has registered the device, the user of the device may establish a user account with a user name and password (block 414). Through this account, the user of the device selects a configuration for the device subject to the controls in the control database 64. When the communication device is a device with no data entry devices, such as a photo frame, or one with limited data input capability, such as the IM device 34, which has a keyboard and mouse control that is smaller than a typical PC, the administrative user and the user may initialize or modify controls or configurations for the device with a PC. Operations with a PC may occur, however, only after the device has been used for the initial registration so the site can obtain the unique identifier and verify the device is capable of being supported by the site 20. Modifications to a device configuration made with a PC are pushed down to the device in response to the device coupling to the network 28 and the communication module commencing communication with the site 20.

Once the device has been registered with the site 20 and the controls and configuration for the device initialized, the device may be used for communication sessions with others over the network 28 using a communication service, such as the instant messaging service 50. The data communication session may occur in a known manner with the user accessing the service 50, for example, through an ISP, logging into the messaging service, and then operating the device to text message with other subscribers. In response to the device coupling to the network 28 for this purpose, the communication module, executing in the background, initiates communication with the support site 20 for application of the controls to the communication occurring through the device 20.

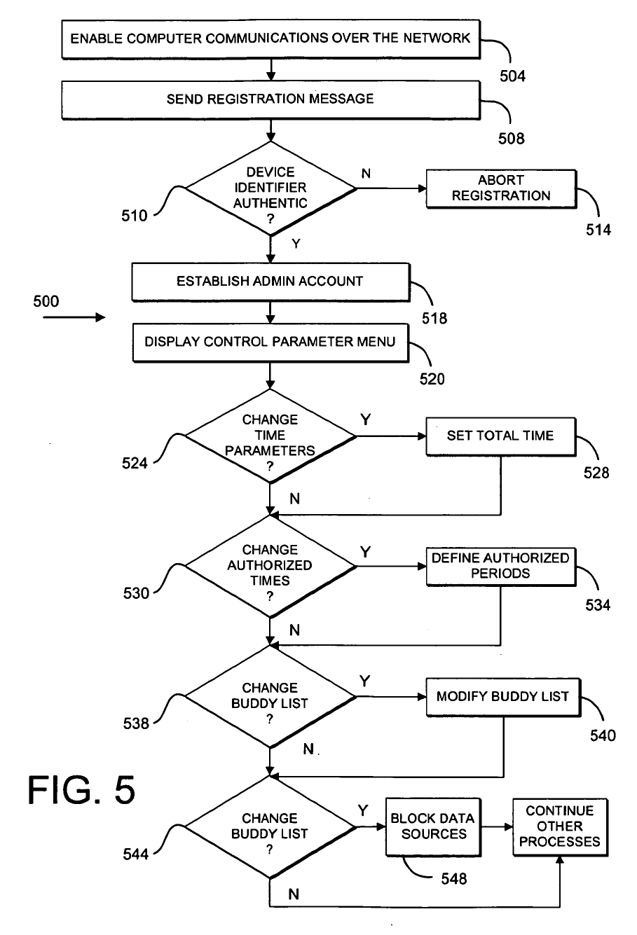

The registration process and initial administrative device setup 500 is shown in FIG. 5. After purchase, a device is brought to a location where the device establishes a wireless link to a wireless router, such as router 38. This initiation of the device is preferably performed by a user that acts as an administrator for the device. The device logs in with a user's account for ISP access to enable computer network communication with other sites on the network 28 through the ISP (block 504). The communication module, in response to detection of communication on the network 28, begins executing in the background and sends a registration message to the regulation/support site gateway 54 (block 508). The registration message includes the unique identifier. The gateway 54 accesses the device database 58 to verify the unique identifier sent by the device is in the database 58 (block 510). If it is not, the registration process is aborted and the user is informed that the device is not authorized for support services (block 514). Otherwise, registration continues.

The registration process includes establishment of an administrative account (block 518). Establishment includes entry of an administrator name and password to control access to the administrative function. A menu of control parameters is presented to the user so the user may view default control parameters for the device (block 520). The administrator may then select control parameters and modify them, if desired. Examples of control parameters for IM device are shown in FIG. 5, although the reader should appreciate that other control parameters for IM devices as well as control parameters for other types of devices may be implemented. For example, the administrator may select a total usage parameter for change (block 524). This parameter limits the total time that the device may be used during a predefined period. For example, the default parameter may equal one week of time during a one week period. That is, unlimited usage may be the default option. The administrator, however, may set the usage to another value, such as a particular number of hours or minutes during a day (block 528). Once the value is modified, another parameter may be selected and modified.

Another parameter that may be used to regulate device usage is authorized time of day usage (block 530). This parameter is used to preclude communication with the device during defined periods. For example, the default parameter may enable communication throughout the twenty-four hours of a day. The administrator may, however, choose to deny use of the device during school hours or late evening usage (block 534). Attempts to use the device during these periods result in a denial of service to the device user. The process may be configured to enable an administrator to select different periods for different days of the week so the usage may be authorized for daytime use on weekends and holidays, but not during school days.

As the device may be used for two-way communication with others, such as text messaging through an instant messaging service, recipient names are collected. In the instant messaging domain, an IM device user builds a buddy list with an IM service provider. Because the IM terminal described in the '077 Patent and herein accesses multiple IM services, a buddy list, which identifies the persons accessed through a particular service, may be accumulated for each service. At the initiation of a communication session with a messaging service, the communication module of the IM device receives the buddy list for the subscriber and provides the buddy list to the support site 20. The buddy lists from the various services to which the user subscribes are merged into a single buddy list and stored in the parental control database in association with the unique device identifier. During an administrator session, the administrator may view the buddy list (block 538) and restrict access to or even issue a block rule against names in the buddy list (block 540). To restrict or block access to a buddy, an administrator defines rules regarding authorization for access to a buddy or authorized times for communications with a buddy. These rules are stored in association with the device identifier.

One issue that arises from communications with others over the network 28 is the use of pseudonyms for persons. Thus, names in the buddy list or some other type of user identification for another type of device may not be recognizable to the administrator. One function that the administrator may enable while viewing a buddy list is to issue a block rule associated with a name in a user identification or buddy list. After the user learns access has been blocked and inquires about the blockage, the administrator may have the user identify the actual name of a buddy in the list. Once the user identifies the buddy, the administrator may initiate an administrative session to delete the block rule or define a restriction rule for the identifier in the buddy list. The restrictions may include limiting communication to particular times of day or identifying a total time that may be spent communicating with a buddy during a specified time period.

A communication device may include the capability to play streaming music from an internet radio station or other source. Similarly, the device may play video and audio data that streams from a source coupled to the network 28 or display data from a source coupled to the network 28. These sources are also reported to the support site by the communication module in the device 34 and stored in the control database 64. During an administrative session, the administrator may review the sources that have been accessed for streaming data or other downloads, such as RSS feeds, podcasts, or photographs (block 544). If the administrator considers any of the sources objectionable for the user, the administrator may activate a block rule for these sources (block 548). Once the administrator has adjusted the control parameters to the settings desired by the administrator, the administrative session is concluded (block 550).

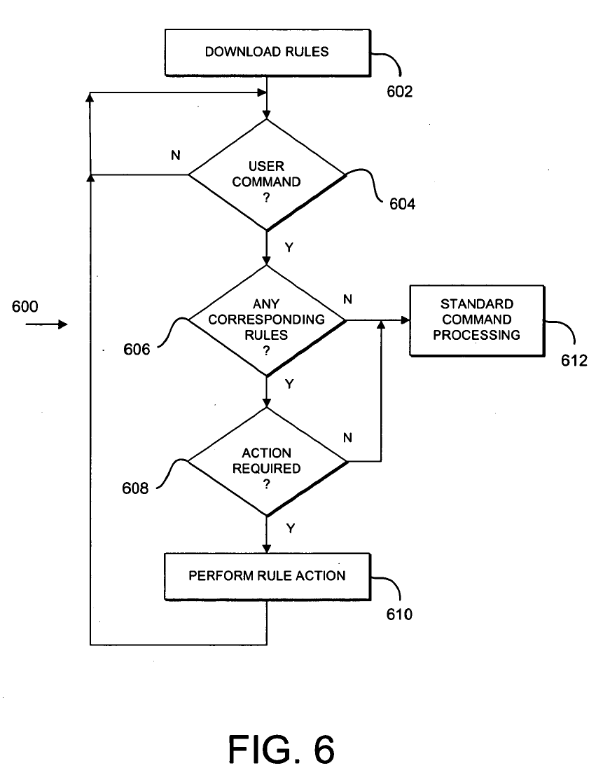

A process performed by a communication module in a computer network communication device is shown in FIG. 6. Upon activation of the device, the communication module sends a message to the regulation site 20 and receives a current set of rules regulating use of the device (block 602). The process 600 then monitors the user's command input to the device (block 604). In response to entry of a command, the process searches the rules to identify any rules that correspond to the entered command (block 606). For any identified rules, the entered command is compared to the identified rules to determine whether the command can be performed or whether any action is to be taken (block 608). Otherwise, standard command processing is performed (block 612).

For example, logging into an IM service with the device 34 results in the IM service downloading a buddy list for buddies accessed through the service. The buddy identifiers in the list are used to search the rules downloaded from the control site to determine whether any buddies have been blocked or are restricted. If any one is blocked, the buddy is not displayed in the display when the user commands a buddy listing be displayed. Any efforts to re-enter the missing buddy result in the processor of the IM device indicating to the user through the display that the action is prohibited. Thus, all commands entered by a user are evaluated against the downloaded rules and the processor responds to the command in accordance to the rule restrictions. After the command has been processed and the appropriate action taken (block 610), the communication module continues to monitor user input for additional processing in accordance with the downloaded rules (block 604).

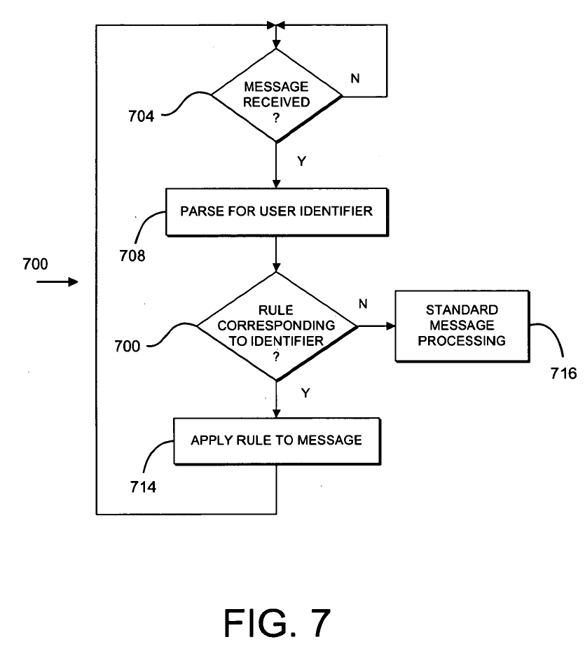

Processing commands for a computer network communication device in accordance with rules downloaded from the control site 20 is effective for dealing with persons who have surreptitiously obtained a user's identifier. An example of a method for processing inbound messages is shown in FIG. 7. When a message is received by the communications module (block 704), the message is parsed by the processor executing the communication application for the device to obtain the user identifier in the message (block 708). The user identifier is used to search the downloaded rules to identify any corresponding rules (block 71 0). If a rule is found, the rule is parsed and applied to the message (block 714). Otherwise, standard message processing is performed (block 716). For example, a block rule corresponding to a buddy identifier results in the message being deleted and the message is not used to open an IM session with the device 34. If a restriction rule is found, the restrictions are applied and the corresponding action taken. For example, if a message is received from a buddy during a prohibited time, the message may be treated as a blocked message. Receiving the message during an authorized period, however, results in the message being presented to the user for an opportunity to open an IM window for a session with the buddy. After a rule is applied, the process continues to monitor for new messages (block 704). The processor executing the IM application may also process outbound messages in a similar manner. For example, commands to send messages to buddies that have been blocked or are restricted are ignored and not executed.

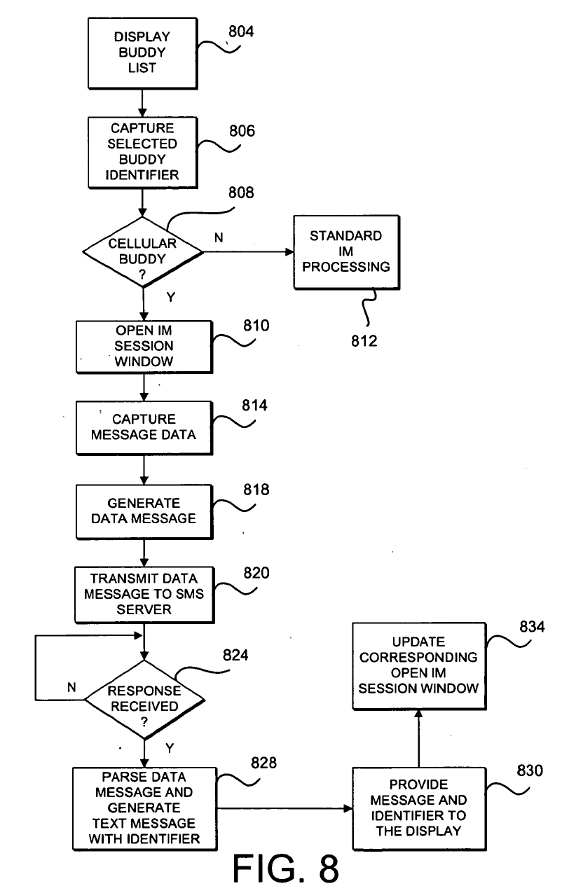

A process implemented by the processor executing an IM application program that enables IM window sessions with a cellular telephone user is shown in FIG. 8. The process 800 begins with the processor of the IM terminal generating a display of a buddy list (block 804). As described above, the buddy list is displayed in accordance with the rules downloaded from the regulation site 20. In response to a user selecting a buddy or recipient identifier in the buddy list that is associated with a cellular telephone number (block 806, 808), the processor executing the IM application opens an IM window for a session with a cellular phone user (block 810). Otherwise, the standard IM session processing is performed (block 812). The window includes the selected recipient identifier so the user of the IM terminal can readily ascertain the person with whom communication is being effected. After the user enters alphanumeric data for a message to the selected recipient with the data entry device of the terminal, the processor receives the data (block 814) and generates a data message incorporating the entered message data (block 818). The processor provides the data message to the communication module for transmission to the SMS server 70 (block 820). The processor keeps the window open while awaiting a response or until the user closes the window. In response to a data message being received from the SMS server (block 824), the processor parses the message, verifies the sender is authorized for communication in accordance with the rules, and generates an alphanumeric message from the content of the received data message (block 828). The processor then provides the display with the generated message and the recipient identifier (block 830). The display updates the IM session window corresponding to the recipient identifier with the generated message (block 834).

This process resembles the standard IM message process with one exception. Instead of sending the data message to an IM service for transmission to the cellular phone, the message is sent to an SMS server for transmission over a cellular network to the cellular phone. As explained above, IM services may include SMS servers for access to one or more cellular networks. These SMS servers, however, differ from IM service to IM service in the cellular networks they access as well as other differences. By directing all of the instant messaging to a single SMS server without regard to an IM service, the data messages that are sent to cellular phone recipients need only comply with a single protocol. When the cellular network is accessed through an IM service, each message needs to be encoded with the protocol for the IM service through which the SMS server is accessed. By encoding the messages with a protocol for a single SMS server, the overhead of converting data messages sent to an IM service that are relayed to the particular SMS server used by the IM service is avoided. Thus, the processor of the device 34 executing the IM application described herein operates the device differently and more efficiently than previously known IM devices.

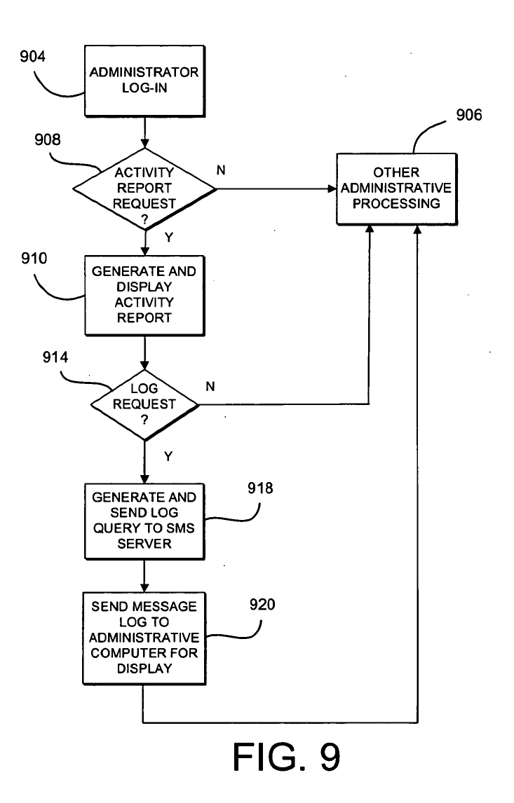

Another advantage of communicating with a SMS server without passing through an IM service is the simplification of empowering parent/administrators to guard access to the IM devices used by their family members more strenuously. One SMS server that may be used with the IM device disclosed herein is the web-based text messaging service known as Joopz™ that is provided by Mobile-Sphere. This service is capable of generating a log of each session between an IM device and a cellular telephone accessed through its server. The log includes the content of each message communicated between the two devices. As shown in FIG. 9, a parent/administrator may log into the control site 20 for administration of a family member's IM device (block 904). In response to a request for an activity report for a device (block 908), the control server generates a report identifying the amount of message traffic between the IM device and each buddy in a buddy list (block 910). Otherwise, other administrative commands are processed (block 906). The activity report may, for example, show the buddy identifier and the number of messages exchanged between the buddy and the device. If the parent/administrator is concerned about the number of messages and/or identity of the buddy, a request may be sent to the site 20 for display of the log of the messages between the buddy and the device (block 914). If no log is requested, other administrative command processing is performed (block 906). In response to the log query, the control site server generates a query for the log to the SMS server (block 918). The query identifies the device and the cellular telephone number corresponding to the buddy. Upon receipt of the log from the SMS server, the control site server sends the log to the computer that the parent/administrator is using (block 920). The parent/administrator may examine the content of the messages and, if restriction or blocking is deemed to be required, the parent/administrator may request generation of appropriate rules for the buddy (block 906). The generation of the rules may proceed as previously described.

Subsequent to the registration process or other administrative session, a user of a computer network communication device may couple to the network 28 through an ISP and initiate communication with the support site 20. This communication is performed in the foreground so the user can view menus and make selections. The menus include configuration menus that enable a user to select theme skins, backgrounds, alert tones, and the like. If these menus are accessed with a PC or other computer and the device configuration is altered, the support site stores the configuration data in the user profile database 60 in association with the unique device identifier. In response to the communication module initiating communication with an IM service, the support site retrieves the new configuration data along with any modified control parameters and rules associated with the unique device identifier. These data are then pushed down to the device. The device installs the configuration data and modifies the stored control parameters and rules by which user commands are evaluated in the device.

During communication sessions on the network 28 using an appropriate communication service, the communication module of a computer network communication device evaluates user commands with the rules obtained from the support site 20. The device is operated in accordance with these rules. Any violations of the rules results in the device 34 taking action consistent with the rules and control parameters. For example, should the user attempt to extend use of the device beyond the time limits specified for the device or for communications with particular users, the processor executing the communication application operates in a way that implements the rule and not the user's command.

If an IM user, for example, attempts to add a buddy to the list that has been blocked by the administrator, the processor detects the blocked status of the buddy identifier and the display of the buddy list continues to hide the blocked buddy. Because the user cannot see the buddy in the list and the processor does not void the blocking action in response to user commands, the user is unable to initiate a communication session with the blocked buddy. Thus, the buddy data are compared to the rules and controls in the downloaded from the control database 64 and the operation of the device by the processor is adjusted accordingly. The adjustment may include the device 34 displaying a message to the user that communication with the buddy has been blocked and that the administrator must be consulted for permission to communicate with the buddy.

In a similar manner, messages to sources for streaming data or other data downloads result in the processor executing a communication application comparing the data source identities to the rules and control parameters. A process for controlling communication with a one-way device, such as a LCD photo frame is shown in FIG. 1O. The process commences when the device couples to the computer communication network (block 950). The device looks for receipt of a message to update the contents of a display or other function of the device (block 954). Upon receipt of a message, the device communicates with control site 20 to obtain the rules corresponding with the user identifier in the received message (block 958). The message is processed with reference to those rules (block 962) and then the device returns to wait for receipt of another message to process (block 954). In one example, a LCD photo frame couples to the computer network 28. A cellular user may capture an image with a camera integrated with the telephone and attempt to send the image to the LCD frame. The phone may send the image as described above. Alternatively, if the phone is equipped with a wireless communication device, such as a Wi-Fi transceiver, the image may be sent through a wireless network access point to an SMS server for delivery to the LCD photo frame. Regardless of how the image is sent to the photo frame, once it is received is processed with reference to the rules downloaded from the control site 20. Consequently, the processor in the device adjusts the operation of the device to implement the rule rather than the user command if a rule regarding the identified source is detected. That is, no display is generated and a message informing the user that the download will not be executed may be displayed. The message may also inform the user that access to the source cannot be obtained without the action of the administrator.

The system and method described above more reliably control operation of mobile devices. The unique device identifier ensures that the user is not able to establish an alternative account or use another subscriber's account that does not have controls or rules regulating its use. Even if the user logs into a communication service with another account, the device still communicates with the control site 20, which downloads the rules and control parameters for operating the device. The processor executing the IM or other communication application parses the user commands with reference to the rules and control parameters downloaded from the support site. Thus, the user is not able to avoid block rules and/or operational restrictions by using a different account.

While the system and method for device control have been illustrated by the description of exemplary processes and system components, and while the various processes and components have been described in considerable detail, applicant does not intend to restrict or in any limit the scope of the appended claims to such detail. Additional advantages and modifications will also readily appear to those skilled in the art. For example, the IM device may alternatively or additionally send data messages to an MMS server to communicate multimedia files with mobile communication devices on a cellular network in a manner similar to that described above with regard to the SMS server. Therefore, the system and method described above in their broadest aspects are not limited to the specific details, implementations, or illustrative examples shown and described. Accordingly, departures may be made from such details without departing from the spirit or scope of applicant's disclosed system and method.

What is claimed is:

1. A mobile computer network communication device that regulates an instant message session with a mobile telephone comprising:
an input device that generates alphanumeric data in response to manipulation of the input device;
a display that generates visible indicia;
a memory for storing data;
a processor that executes an instant messaging (IM) application program that generates data messages in a Short Message Service (SMS) protocol in response to a recipient identifier retrieved from memory corresponding to a cellular telephone number; and
a communication module that communicates the data messages in the SMS protocol with a SMS server over a computer communication network.

2. The mobile computer network communication device of claim 1, the processor searching a plurality of rules stored in the device to detect rules corresponding to the cellular telephone number.

3. The mobile computer network communication device of claim 3, the processor executing the IM application program terminating generation of the data messages in the SMS protocol in response to a block rule in the plurality of rules corresponding to the cellular telephone number.

4. The mobile computer network communication device of claim 1, the processor executing the IM application program blocking display of a buddy identifier in a buddy list in response to the processor detecting a rule in a plurality of rules downloaded from a control site corresponding to the buddy identifier.

5. A system for regulating a data communication session with a mobile computer network communication device comprising:
a mobile computer network communication device that communicates data messages generated in a Short Message Service (SMS) server protocol with a SMS server;
a SMS server that receives the data messages in the SMS server protocol and transmits SMS messages over a computer communication network;
a control server that stores rules for operation of the computer network communication device; and
a computer network communication device coupled to the SMS server and the control server through the computer communication network, the computer network communication device processing data messages received from the mobile computer network communication device with reference to rules downloaded from the control server that correspond to the mobile computer network communication device.

6. The system of claim 5 wherein the mobile computer network communication device is a cellular telephone.

7. The system of claim 5 wherein the computer network communication device is a two-way communication device.

8. The system of claim 7 wherein the two-way communication device is an instant messaging (IM) terminal.

9. The system of claim 8, the IM terminal further comprising:
an input device that generates alphanumeric data in response to manipulation of the input device;
a display that generates visible indicia;
a memory for storing data;
a processor that executes an IM application program that generates data messages in the SMS protocol in response to a recipient identifier retrieved from memory corresponding to a cellular telephone number; and
a communication module that communicates the data messages in the SMS protocol with the SMS server over the computer communication network.

10. The system of claim 9, the processor of the IM terminal searching a plurality of rules downloaded from the control server to detect rules corresponding to the cellular telephone number.

11. The system of claim 10, the processor executing the IM application program terminating generation of the data messages in the SMS protocol in response to a block rule in the plurality of rules corresponding to the cellular telephone number.

12. The system of claim 11, the processor executing the IM application program blocking display of a buddy identifier in a buddy list in response to the processor detecting a rule in a plurality of rules downloaded from the control site corresponding to the buddy identifier.

13. The system of claim 5 wherein the computer network communication device is a one-way communication device.

14. The system of claim 13 wherein the one-way communication device is a LCD photo frame.

15. A computer network communication device comprising:
a device identifier stored in the device;
a communication module configured to download rules corresponding to the device identifier from a control site remote from the device; and
a processor configured to process data messages received from other computer network communication devices over a computer network with reference to the downloaded rules.

16. The device of claim 15 wherein the processor is configured to process data messages generated in a Short Message Service (SMS) server protocol.

17. The device of claim 15 wherein the device is a two-way communication device.

18. The device of claim 17 wherein the two-way communication device is an instant messaging (IM) terminal.

19. The device of claim 18, the IM terminal further comprising:
an input device that generates alphanumeric data in response to manipulation of the input device;
a display that generates visible indicia; and
the processor is further configured to execute an IM application program that generates data messages in the SMS protocol in response to a recipient identifier retrieved from memory corresponding to a cellular telephone number; and
the communication module is further configured to communicate the data messages in the SMS protocol with a SMS server over the computer communication network.

20. The device of claim 15 wherein the computer network communication device is a one-way communication device.
